(19) United States
(12) Patent Application Publication
(10) Pub. No.: US 2005/0166180 A1
(43) Pub. Date: Jul. 28, 2005

(54) Web services enablement and deployment substrate

(76) Inventors: Scott C. Lemon, Charleston, UT (US); Bruce K. Grant JR., Pleasant Grove, UT (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/917,657

(22) Filed: Aug. 13, 2004

Related U.S. Application Data
(60) Provisional application No. 60/495,413, filed on Aug. 15, 2003.

(51) Int. Cl. G06F 9/44

(52) U.S. Cl. 717/106; 717/109

(57) ABSTRACT

A computer-readable medium for storing program data is disclosed. The program data includes executable instructions for implementing a method in a computing device. The method involves providing a user interface for development of an application. The method also involves receiving a user selection of one or more web services to be included in the application. The method also involves searching for the one or more web services on the computing device and on other computing devices that are accessible to the computing device. The method also involves receiving user instructions for interconnecting inputs and outputs of the one or more web services.

### RELATED APPLICATIONS

This application claims the benefit of U.S. Provisional Application No. 60/495,413, entitled “Web Services Enablement And Deployment Substrate,” filed Aug. 15, 2003, with inventors Scott C. Lemon and Bruce K. Grant, Jr., which is assigned to the assignee of the present invention and which is hereby incorporated by reference in its entirety.

### TECHNICAL FIELD

The present invention relates generally to computers and computer-related technology. More specifically, the present invention relates to a web services enablement and deployment substrate.

### BACKGROUND

Computer technology has entered many areas to simplify manual tasks and to make information more readily available. Most people use several computer programs every day that greatly simplify their work day. In addition, through the use of a computer, vast amounts of information are readily available. Computer software and electronic information sources are typically found on storage media or storage devices such as hard drives, CD-ROMs, DVD-ROMs, etc., on a local computer, on a local computer network or a global computer network, such as the Internet.

Computer programs can be used for many purposes including assisting a person in performing his or her job. For example, word processors help computer users prepare documents, spreadsheet programs help users perform accounting functions and numerical analysis, diagnostic programs assist users in diagnosing problems, etc. There are many programs available to help users with almost any need they may have.

Like other forms of technology, computer-related technology is built upon what came before, i.e., the previous advancement and technology and knowledge. Initially there were many different kinds of computer hardware (e.g., microprocessor chips), much of it proprietary. Over time certain specific brands and technologies became popular (e.g., microprocessors manufactured by Intel and AMD) and were adopted by a majority of users. As a result, many companies stopped producing some of the other proprietary hardware, so that today there are not as many different kinds of computer hardware.

Computer hardware, such as microprocessors, acted as a substrate or a core foundation upon which the next technological advancement could occur. When there were many different hardware architectures it was nearly impossible for a single operating system to function across all of the different technologies and computer architectures. However, after the consolidation of hardware architectures, this made it possible for a few operating systems to become dominant. Once again, over time a few operating systems have become dominant. The most popular operating systems in use today include Microsoft Windows®, Macintosh®, UNIX®, and some others.

Now that there has been a consolidation of operating systems, the functionality of the different operating systems has become somewhat homogenized. The functionality performed by one operating system is, more or less, performed by other popular operating systems. There are differences and semantics, but the capabilities are largely symmetric and as time goes by they are becoming more and more similar. In view of the foregoing, benefits may be realized by systems and methods for enabling the development of applications that are not dependent upon any specific operating system.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram illustrating levels of abstraction in computer systems and environments;

FIG. 2 is a block diagram illustrating the use of an application that runs on the application substrate;

FIG. 3 illustrates an embodiment of a user interface for an application substrate;

FIG. 4 illustrates a generic language encapsulator that creates web services wrappers for software

FIG. 5 illustrates an embodiment of a method for developing an application;

FIG. 6 illustrates an embodiment of a method for deploying an application; and

FIG. 7 is a block diagram illustrating the major hardware components typically utilized in a computing device.

### DETAILED DESCRIPTION

A computer-readable medium for storing program data is disclosed. The program data includes executable instructions for implementing a method in a computing device. The method involves providing a user interface for development of an application. The method also involves receiving a user selection of one or more web services to be included in the application. The method also involves searching for the one or more web services on the computing device and on other computing devices that are accessible to the computing device. The method also involves receiving user instructions for interconnecting inputs and outputs of the one or more web services.

In some embodiments, the method also involves packaging the application with a manifest that includes a list of the one or more web services to be included in the application. The method may also involve encapsulating the application to expose the application as a web service.

In some embodiments, the user interface may be a graphical user interface. In such embodiments, the user instructions for interconnecting the one or more web services may be received via a series of drag-and-drop operations.

Another embodiment of a computer-readable medium for storing program data is also disclosed. The program data includes executable instructions for implementing a method in a computing device. The method involves receiving a user instruction to deploy an application. The method also involves determining requirements of the application. The method also involves determining whether the computing device satisfies the requirements of the application. The method also involves identifying one or more web services on which the application depends. The method also involves deploying the one or more web services. The method also involves instantiating the application. In some embodiments, the application does not directly interact with an operating system running on the computing device. Also, in some embodiments, deploying a web service comprises performing similar steps for the web service that are performed to deploy the application.

In some embodiments, if the computing device does not satisfy the requirements of the application the method also involves locating one or more other computing devices that satisfy the requirements, and transferring at least some of the application to the one or more other computing devices that satisfy the requirements.

In some embodiments, the requirements include a virtualizer. Alternatively, or in addition, the requirements may include one or more hardware capabilities. Alternatively, or in addition, the requirements may include one or more services performed by the operating system.

In some embodiments, at least some of the one or more web services are located on the computing device. Alternatively, or in addition, at least some of the one or more web services are located on one or more other computing devices that are accessible to the computing device. Communication with the one or more web services may occur in accordance with Simple Object Access Protocol.

A computing device is also disclosed. The computing device includes a processor and memory in electronic communication with the processor. Instructions are stored in the memory. The instructions are executable to implement a method that involves providing a user interface for development of an application. The method also involves receiving a user selection of one or more web services to be included in the application. The method also involves searching for the one or more web services on the computing device and on other computing devices that are accessible to the computing device. The method also involves receiving user instructions for interconnecting inputs and outputs of the one or more web services.

Another embodiment of a computing device is disclosed. The computing device includes a processor and memory in electronic communication with the processor. Instructions are stored in the memory. The instructions are executable to implement a method that involves receiving a user instruction to deploy an application. The method also involves determining requirements of the application. The method also involves determining whether the computing device satisfies the requirements of the application. The method also involves identifying one or more web services on which the application depends. The method also involves deploying the one or more web services. The method also involves instantiating the application.

A method in a computing device is also disclosed. The method involves providing a user interface for development of an application. The method also involves receiving a user selection of one or more web services to be included in the application. The method also involves searching for the one or more web services on the computing device and on other computing devices that are accessible to the computing device. The method also involves receiving user instructions for interconnecting inputs and outputs of the one or more web services.

Another embodiment of a method in a computing device is also disclosed. The method involves receiving a user instruction to deploy an application. The method also involves determining requirements of the application. The method also involves determining whether the computing device satisfies the requirements of the application. The method also involves identifying one or more web services on which the application depends. The method also involves deploying the one or more web services. The method also involves instantiating the application. In some embodiments, the application does not directly interact with an operating system running on the computing device. Also, in some embodiments, deploying a web service comprises performing similar steps for the web service that are performed to deploy the application.

Various embodiments of the invention are now described with reference to the Figures, where like reference numbers indicate identical or functionally similar elements. It will be readily understood that the embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Several aspects of the embodiments described herein will be illustrated as software modules or components stored in a computing device. As used herein, a software module or component may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Note that the exemplary embodiment is provided as an exemplar throughout this discussion, however, alternate embodiments may incorporate various aspects without departing from the scope of the present invention.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

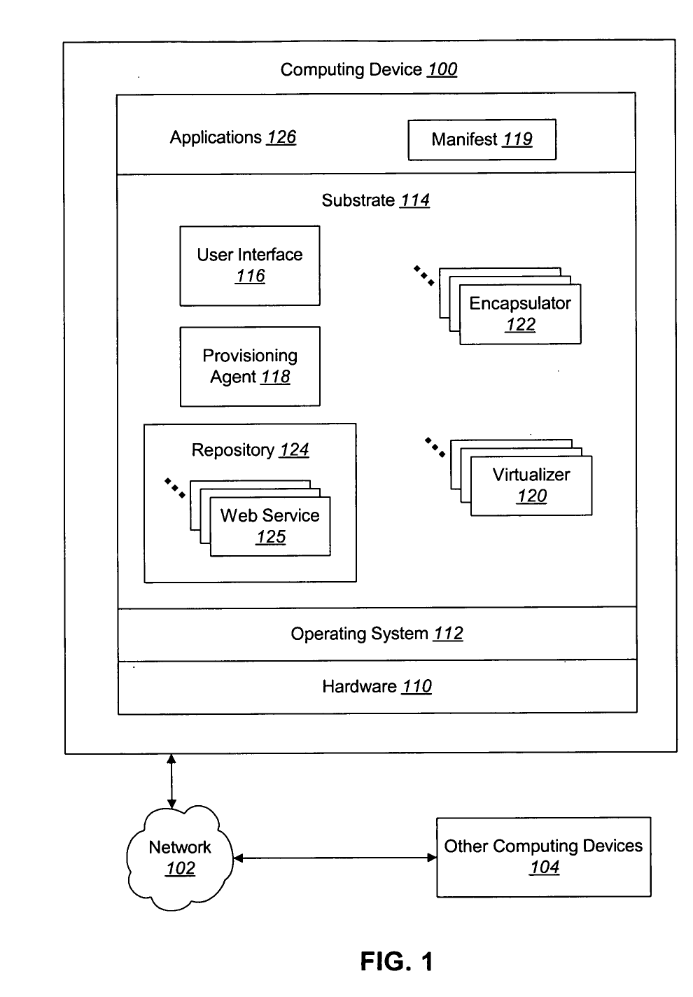

FIG. 1 is a block diagram illustrating levels of abstraction in computer systems and environments. A computing device 100 is shown. The computing device 100 is in electronic communication with one or more other computing devices 104 via one or more networks 102. Many different kinds of networks 102 are known to those skilled in the art. Examples of networks 102 include local area networks (LANs), wide area networks (WANs), the Internet, and so forth. Embodiments disclosed herein are not limited to any particular kind of network 104.

The computing device 100 includes hardware 110. Examples of different kinds of hardware 110 that may be included in a computing device 100 include a processor, memory, communication interfaces, input devices, output devices, and so forth.

The computing device 100 also includes an operating system 112. The operating system 112 provides a powerful abstraction above the hardware 110. The operating system 112 may perform task scheduling and management, device management, memory allocation, and various other functions. Examples of operating systems 112 include Microsoft Windows®, Macintosh®, Microsoft DOS®, Unix®, and so forth.

The computing device 100 also includes an application substrate 114. The application substrate 114 provides the same abstraction for the operating system 112 that the operating system 112 provides for the hardware 110. The application substrate 114 may be configured so that it will run on many different operating systems 112. In addition, the application substrate 114 may support applications that are written in many different programming languages. The application substrate 114 includes a user interface 116 for a user to interact with the substrate 114. The application substrate 114 also includes a provisioning agent 118, one or more virtualizers 120, one or more encapsulators 122, and a repository 124.

The computing device 100 also includes one or more applications 126. Applications 126 are programs that perform one or more functions for the user. In the illustrated embodiment, the applications 126 interact directly with the application substrate 114 and not the operating system 112.

The provisioning agent 118 of the application substrate 114 is responsible for deploying an application 126. In embodiments disclosed herein, applications 126 may be dependent on one or more web services 125. A “web service” 125, as that term is used herein, refers to any piece of software that is capable of being located via an Internet protocol and interacting with an application 126. The requirements and dependencies of an application 126 may be defined in a manifest 119 that is associated with the application 126.

In deploying an application 126, the provisioning agent 118 accesses the manifest 119 of the application 126 to determine its requirements and dependencies. The requirements may include an appropriate virtualizer 120, services performed by the operating system 112, and basic hardware 110 capabilities. The dependencies may include one or more web services 125. The manifest 119 may also include a description of each web service's 125 functionality.

The provisioning agent 118 may determine if the local computing device 100 meets the requirements of the application 126. If the minimum requirements have not been met, the provisioning agent 118 may then see if any other computing devices 104 meet the requirements. If another computing device 104 is not found that meets the requirements, an error message may be returned to the user through the user interface 116.

If the requirements may be satisfied (either via the local computing device 100 or other computing devices 104), the provisioning agent 118 searches in the repository 124 for the web services 125 listed in the manifest 119. If the web services 125 are not found in the local repository 124, the provisioning agent 118 may then search the repositories 124 of the other computing devices 104 for the web services 125 listed in the manifest 119 of the application 126.

When the provisioning agent 118 finds a web service 125 that is listed in the manifest 119, the provisioning agent 118 instantiates the web service 125. The provisioning agent 118 may also check the requirements and dependencies of each of the web services 125 that are instantiated, in the same manner as described above. When all of the web services 125 listed in the manifest 119 are instantiated, the application 126 is ready for use by the user. The provisioning agent 118 may also provide monitoring services and/or automatically distribute an application 126 to other computing devices 104 based on load or requirements of the application 126.

A virtualizer 120 is a component that provides a virtual execution environment. The application substrate 114 may include several different virtualizers 120. Examples of virtualizers 120 include, but are not limited to, Java, Perl, Python, PHP, Ruby, Rotor (C#), VB.NET, Basis, Micro Focus Cobol, etc.

An encapsulator 122 is a component that exposes a service, data or logic through a standard interface. The Simple Object Access Protocol (SOAP) is an example of an interface that an encapsulator 122 might expose. Examples of types of encapsulators 122 include, but are not limited to, a terminal session encapsulator, an SQL encapsulator, a generic language encapsulator, static encapsulators, and the like. The generic language encapsulator 122 may be used to encapsulate non-SOAP aware code. For example, code written in Java, Perl, PHP, Python or Ruby may be non-SOAP aware code. A static encapsulator may encapsulate specific OS services or protocols. A static encapsulator might be operating system specific.

Of course, FIG. 1 illustrates only one possible configuration of the levels of abstraction in computer systems and environments. Those skilled in the art will recognize that various other architectures and components may be utilized.

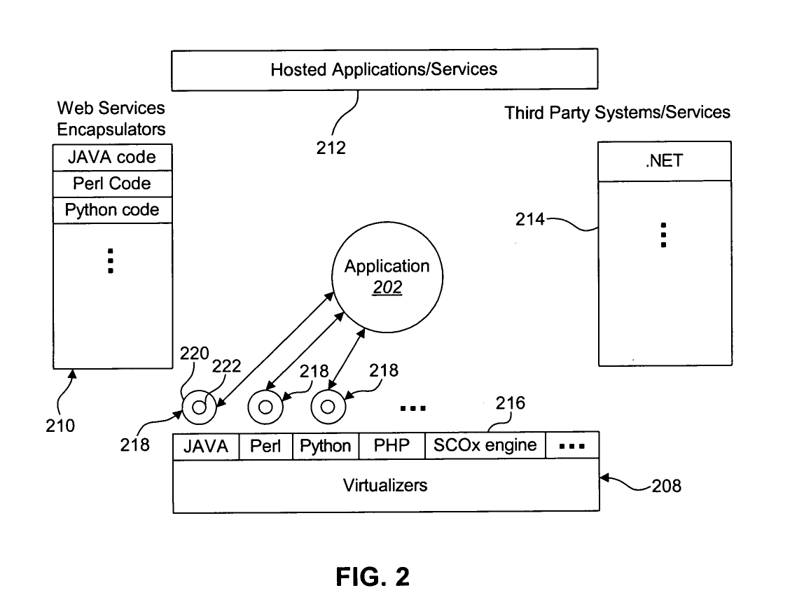

FIG. 2 is a block diagram illustrating the use of an application 202 that runs on the application substrate. The encapsulators 210 may expose services, data or logic through standard interfaces for the application 202. The virtualizers 208 provide virtual execution environments. As shown, many of the virtualizers 208 may be commercially available environments such as JAVA, Perl, Python, PHP, and the like. Additionally an SCOx assembly execution engine 216 may be a virtualizer. The SCOx assembly execution engine is a virtualizer that executes assembled web services and defined business processes.

Hosted 212 applications and/or services may also be used by or with the application 202. Third party 214 systems and/or services 214, such as the .NET framework, may also be used by or with the application 202.

Wrapped programs 218 include programs 222 written in the various languages or with the various environments shown. Wrappers 220 have been added that are web services wrappers 220 for the programs 222.

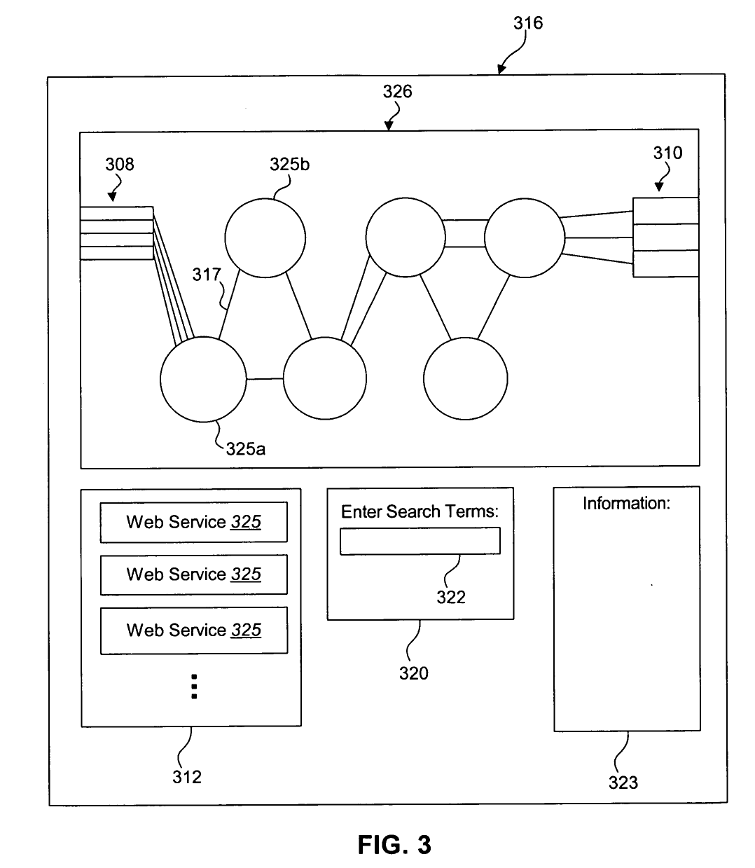

FIG. 3 illustrates an embodiment of a user interface 316 for an application substrate 114. The user interface 316 allows users to drag and drop web services 325 to create an application 326. The different web services 325 may be “wired” together with other web services 325. The inputs 308 to the application 326 and the outputs 310 from the application 326 are shown in FIG. 3. As shown, the inputs 308 are taken and processed by the various web services 325 to provide the outputs shown 310. The outputs from a particular web service 325 may be provided as inputs to another web service 325. For example, in FIG. 3, the output 317 of web service 325a is provided as the input 317 to web service 325b.

The user interface 316 provides a convenient way for a user to develop applications 326. Available web services 325 may be displayed in a display window 312. The display window 312 may display some or all of the web services 325 that are available to the user to develop an application 326. The available web services 325 may be located on the local computing device 100 or on other computing devices 104. In some embodiments, each web service 325 may be represented graphically along with a brief description of the functions performed by the web service 325.

The user interface 316 may also include a search window 320 to facilitate the selection of a web service 325 by a user. The search window 320 may include a user input element 322 (e.g., text box, dialog box, etc.) that allows a user to enter search terms. When a user desires to find a web service 325 that performs a particular function, the user may enter search terms describing the desired function into the user input element 322. In response to the user entering the search terms, the application substrate 114 may search for web services 325 matching the user-specified criteria in the repository 124 on the local computing device 100 and/or repositories on other computing devices 104. To locate a web service 325 with certain functionality, the application substrate 114 may examine the manifests of web services 325 for key terms. Once found, the application substrate 114 may display the location and/or description of the located web services 325 that satisfy the terms of the search in the search window 320.

Additionally, the user interface 316 may include an information window 323. The information window 323 may provide a user with information about a selected web service 325, such as the requirements, dependencies, input data types, output data types, etc. The information window 323 may also display errors and information about whether the computing device 100 meets the requirements of the selected web service 325.

In “wiring” together the different web services 325 that are used in the application 326, the user specifies which inputs will be linked with which outputs. If each input and output is not linked, a error message may be returned to the user in the information window 323. The information window 323 may also display information on each interconnection such as the input data type and requirements and the output data type.

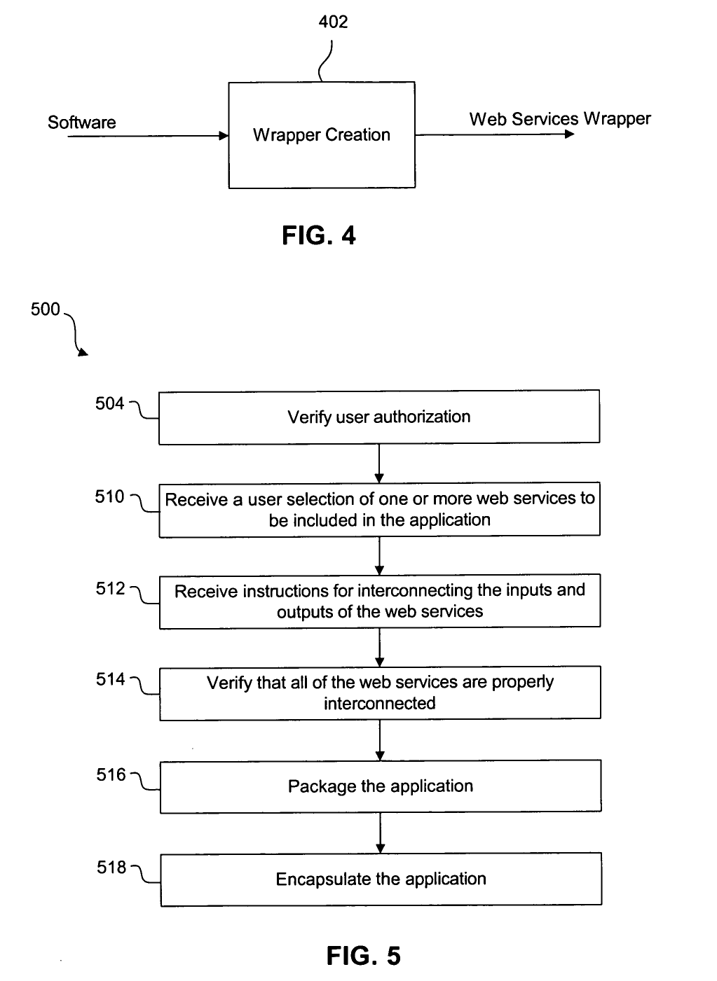

Once an application 326 has been created, the application 326 may itself be provided to others as a web service 325. FIG. 4 illustrates a generic language encapsulator 402 that creates web services wrappers for software. This generic language encapsulator 402 takes software, such as an application 326 or other bits of code, as an input and analyzes the software for any functions that should or may be transformed into a web service. The generic language encapsulator 402 then creates a wrapper or stubs for the software that implement the web services interfaces.

FIG. 5 illustrates an embodiment of a method 500 for developing an application 126. The method 500 may be performed by the application substrate 114. The method 500 may begin by verifying 504 user authorization. Once user authorization is verified, the application substrate 114 may receive 510 a user selection of one or more web services 125 to be included in the application 126. In some embodiments, the user may enter search terms describing a desired function into the user input element 322 of the user interface 316. In response to the user entering the search terms, the application substrate 114 may search for web services 125 matching the user-specified criteria in the repository 124 on the local computing device 100 and/or repositories on other computing devices 104. Once found, the application substrate 114 may display the location and/or description of the located web services 125 that satisfy the search terms.

The application substrate 114 may also receive 512 instructions for interconnecting the inputs and outputs of the web services 125 selected in step 510. As discussed previously, this may involve providing a drag-and-drop user interface 316 that allows the user to interconnect the inputs and outputs to the application 126 and the inputs and outputs of the various web services 125. An exemplary user interface 316 is illustrated in FIG. 3 and discussed above in connection therewith.

The application substrate 114 may then verify 514 that all of the web services 125 are properly interconnected. This may involve verifying that the inputs 308 to the application 126 are each connected to an input to a web service 125, that the outputs 310 of the application 126 are each connected to an output of a web service 125, and that the inputs and outputs of the different web services 125 are each connected appropriately.

The application substrate 114 may then package 516 the application 126. This may involve creating a manifest 119 that includes the requirements and the dependencies of the application 126. For example, the manifest 119 may include a list of the web services 125 that are used by the application 126.

The application substrate 114 may then encapsulate 518 the application 126. More specifically, the application 126 may be exposed as a web service 125 through a standard interface, such as SOAP. An encapsulator 122 may be used to perform this step. The application 126 may then be placed in a repository 124 on the computing device 100. Other applications can then access and interact with the application 126.

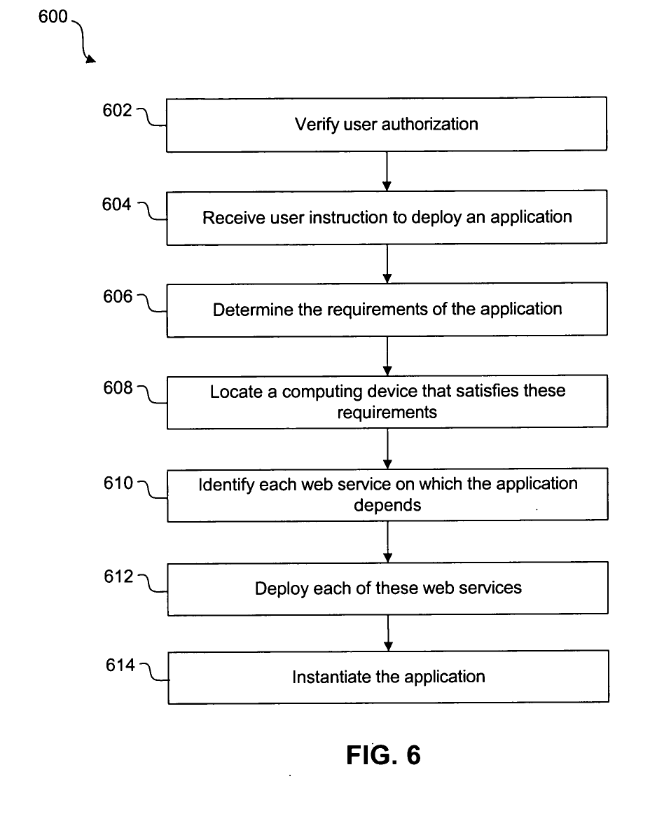

FIG. 6 illustrates an embodiment of a method 600 for deploying an application 126. The method 600 may be performed by the application substrate 114, and more specifically, by the provisioning agent 118. The method 600 may begin by verifying 602 user authorization. The method 600 may then involve receiving 604 a user instruction to deploy an application 126.

The method 600 may then involve determining 606 the requirements of the application 126, and then locating 608 a computing device that satisfies these requirements. As indicated above, the requirements may include an appropriate virtualizer 120 and basic hardware 110 capabilities. If the local computing device 100 does not satisfy the requirements of the application 126, the application substrate 114 may locate another computing device 104 that satisfies these requirements and that may be used to run the application 126.

The method 600 may then involve identifying 610 each web service 125 on which the application 126 depends. As indicated above, the application 126 may be dependent on web services 125 that are located in the repository 124 on the local computing device 100. Alternatively, the application 126 may be dependent on web services 125 that are located on other computing devices 104 that are in electronic communication with the local computing device 100.

The method 600 may then involve deploying 612 each web service 125 on which the application 126 depends. This may involve performing some or all of the steps described in connection with the method 600 shown in FIG. 6 for each web service 125 on which the application 126 depends. For example, the provisioning agent 118 may determine the requirements of each web service 125, locate one or more computing devices that satisfy these requirements, identify the dependencies of each web service 125, and instantiate additional web services 125 as needed. The method 600 may then involve instantiating 614 the application 126.

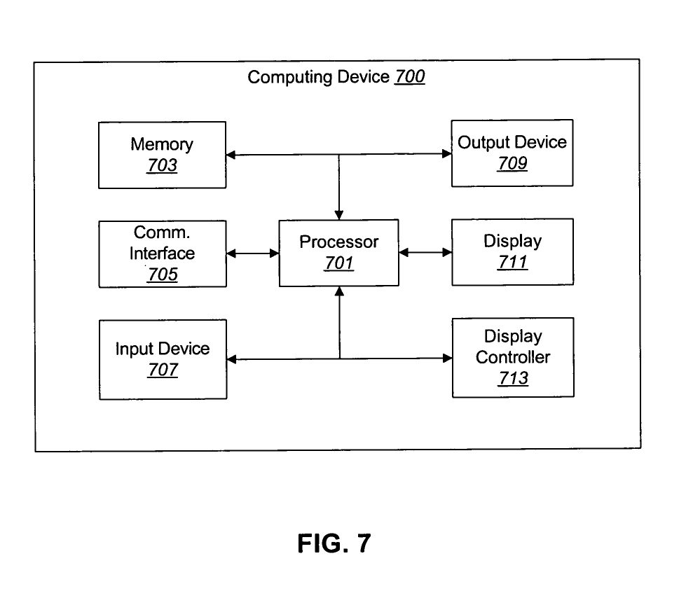

FIG. 7 is a block diagram illustrating the major hardware components typically utilized in a computing device 700. The illustrated components may be located within the same physical structure or in separate housings or structures.

The computing device 700 includes a processor 701 and memory 703. The processor 701 controls the operation of the computing device 700 and may be embodied as a microprocessor, a microcontroller, a digital signal processor (DSP) or other device known in the art. The processor 701 typically performs logical and arithmetic operations based on program instructions stored within the memory 703.

As used herein, the term “memory” 703 is broadly defined as any electronic component capable of storing electronic information, and may be embodied as read only memory (ROM), random access memory (RAM), magnetic disk storage media, optical storage media, flash memory devices in RAM, on-board memory included with the processor 701, EPROM memory, EEPROM memory, registers, etc. The memory 703 typically stores program instructions and other types of data. The program instructions may be executed by the processor 801 to implement some or all of the methods disclosed herein.

The computing device 700 typically also includes one or more communication interfaces 705 for communicating with other electronic devices. The communication interfaces 705 may be based on wired communication technology, wireless communication technology, or both. Examples of different types of communication interfaces 705 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 700 typically also includes one or more input devices 707 and one or more output devices 709. Examples of different kinds of input devices 707 include a keyboard, mouse, microphone, remote control device, button, joystick, trackball, touchpad, lightpen, etc. Examples of different kinds of output devices 709 include a speaker, printer, etc. One specific type of output device which is typically included in a computer system is a display device 711. Display devices 711 used with embodiments disclosed herein may utilize any suitable image projection technology, such as a cathode ray tube (CRT), liquid crystal display (LCD), light-emitting diode (LED), gas plasma, electroluminescence, or the like. A display controller 713 may also be provided, for converting data stored in the memory 703 into text, graphics, and/or moving images (as appropriate) shown on the display device 711.

Of course, FIG. 7 illustrates only one possible configuration of the computing device 700. Those skilled in the art will recognize that various other architectures and components may be utilized. In addition, various standard components are not illustrated in order to avoid obscuring aspects of the invention.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. A computer-readable medium for storing program data, wherein the program data comprises executable instructions for implementing a method in a computing device, the method comprising:
providing a user interface for development of an application;
receiving a user selection of one or more web services to be included in the application;
searching for the one or more web services on the computing device and on other computing devices that are accessible to the computing device; and
receiving user instructions for interconnecting inputs and outputs of the one or more web services.

2. The computer-readable medium of claim 1, wherein the method further comprises packaging the application with a manifest that comprises a list of the one or more web services to be included in the application.

3. The computer-readable medium of claim 2, wherein the method further comprises encapsulating the application to expose the application as a web service.

4. The computer-readable medium of claim 1, wherein the user interface is a graphical user interface.

5. The computer-readable medium of claim 4, wherein the user instructions for interconnecting the one or more web services are received via a series of drag-and-drop operations.

6. A computer-readable medium for storing program data, wherein the program data comprises executable instructions for implementing a method in a computing device, the method comprising:
receiving a user instruction to deploy an application;
determining requirements of the application;
determining whether the computing device satisfies the requirements of the application;
identifying one or more web services on which the application depends;
deploying the one or more web services; and
instantiating the application.

7. The computer-readable medium of claim 6, wherein if the computing device does not satisfy the requirements of the application the method further comprises:
locating one or more other computing devices that satisfy the requirements; and
transferring at least some of the application to the one or more other computing devices that satisfy the requirements.

8. The computer-readable medium of claim 6, wherein the application does not directly interact with an operating system running on the computing device.

9. The computer-readable medium of claim 6, wherein the requirements comprise a virtualizer.

10. The computer-readable medium of claim 6, wherein the requirements comprise one or more hardware capabilities.

11. The computer-readable medium of claim 6, wherein the requirements comprise one or more services performed by the operating system.

12. The computer-readable medium of claim 6, wherein at least some of the one or more web services are located on the computing device.

13. The computer-readable medium of claim 6, wherein at least some of the one or more web services are located on one or more other computing devices that are accessible to the computing device.

14. The computer-readable medium of claim 13, wherein communication with the one or more web services occurs in accordance with Simple Object Access Protocol.

15. The computer-readable medium of claim 6, wherein deploying a web service comprises performing similar steps for the web service that are performed to deploy the application.

16. A computing device, comprising:
a processor;
memory in electronic communication with the processor;
instructions stored in the memory, the instructions being executable to implement a method comprising:
providing a user interface for development of an application;
receiving a user selection of one or more web services to be included in the application;
searching for the one or more web services on the computing device and on other computing devices that are accessible to the computing device; and
receiving user instructions for interconnecting inputs and outputs of the one or more web services.

17. A computing device, comprising:
a processor;
memory in electronic communication with the processor;
instructions stored in the memory, the instructions being executable to implement a method comprising:
receiving a user instruction to deploy an application;
determining requirements of the application;
determining whether the computing device satisfies the requirements of the application;
identifying one or more web services on which the application depends;
deploying the one or more web services; and
instantiating the application.

18. In a computing device, a method comprising:
providing a user interface for development of an application;
receiving a user selection of one or more web services to be included in the application;
searching for the one or more web services on the computing device and on other computing devices that are accessible to the computing device; and
receiving user instructions for interconnecting inputs and outputs of the one or more web services.

19. In a computing device, a method comprising:
receiving a user instruction to deploy an application;
determining requirements of the application;
determining whether the computing device satisfies the requirements of the application;
identifying one or more web services on which the application depends;
deploying the one or more web services; and
instantiating the application.
